(19) United States
(12) Patent Application Publication
(10) Pub. No.: US 2024/0083073 A1
(43) Pub. Date: Mar. 14, 2024

(54) Recycling of Fibre Reinforced Polymer Materials

(71) Applicant: Jeosal Materials Research Corporation, Kingston (CA)

(72) Inventor: Osayuki Osazuwa, Kingston (CA)

(21) Appl. No.: 17/767,805

(22) PCT Filed: Oct. 19, 2020
(86) PCT No.: PCT/CA2020/051364

§ 371 Date: Apr. 8, 2022

Related U.S. Application Data
(60) Provisional application No. 62/913,832, filed on Oct. 11, 2019.

(51) Int. Cl. B29B 17/02; B29B 13/10; B29B 17/04; C08J 11/06

(52) U.S. Cl. CPC B29B 17/021; B29B 13/10; B29B 17/0404; C08J 11/06; B29K 2063/00

(57) ABSTRACT

A method and apparatus for recovering fibres from fibre reinforced polymer (FRP) materials uses a thermomechanical process to produce high quality recovered fibres and powdered polymer resin. The thermo- (cryo-) mechanical process uses a combination of a selected range of temperatures and mechanical force, and is chemical and solvent-free, and produces zero waste. Fibre length remains unchanged after processing and mechanical properties of the recovered fibres are comparable to or better than those of virgin fibres. The recovered fibres and powdered polymer resin may be used to make new FRP products.

### FIELD

The invention relates generally to recycling of fibre reinforced polymer materials, and more particularly, to methods for recovering intact fibres and powdered polymer resin that may be re-used, and to apparatus for carrying out the methods.

### BACKGROUND

Fibre reinforced polymers (FRP) are composite materials made up of reinforcing fibres such as glass or carbon fibres embedded in a polymer matrix to form a strong, resilient, relatively stiff structure. The polymer matrix may be an unsaturated polyester, vinyl ester, phenolic, or epoxy compound. FRP are increasingly used to replace traditional materials in industrial, technological, sporting, transportation, and construction applications.

Although desirable in many applications and service life, the resilience and durability of FRP make them energy intensive to recycle and highly resistant to break down naturally, and thus they are difficult to recycle or reuse at end-of-life. Novel, economically viable, and ecologically sustainable solutions for recycling or reusing of FRP wastes are needed, as the environmental impact of these materials disposed in landfills is accelerating the urgency to reach more industrial scale solutions for the recycling of these composites.

Various recycling techniques have been proposed in the last 20 years, such as mechanical processes (mainly grinding) [2-6], pyrolysis and other thermal processes [7-11], and solvolysis [12-15]. Some of these have been used to a varying degree of success. Some of these techniques, particularly mechanical grinding and pyrolysis, have reached industrial scale, and are commercially exploited. However, these techniques are either energy intensive, produce structurally inferior products, or employ processing conditions—excessive heat and harmful chemicals—that are detrimental to the environment and can pose safety risks for humans.

### SUMMARY

Described herein are processes for producing high quality recovered fibre and resin powder products from fibre reinforced polymer (FRP). Embodiments are energy efficient, cost effective, environmentally benign, generate substantially zero waste, and may utilize commercially available processing equipment. Waste FRP items may be subjected to a process as described herein, and the recovered products may be recycled in the manufacture of new FRP items.

According to one aspect, there is provided a method for recovering fibres and resin powder from FRP material; comprising: disposing FRP in a machine having at least one rotor, and simultaneously: operating the at least one rotor to apply mechanical force to the FRP; and subjecting the FRP to a selected temperature that does not damage the fibres; wherein the combination of mechanical force and selected temperature for a selected duration provides fibres that are substantially free of polymer, and polymer resin powder.

In one embodiment, the method comprises subjecting the FRP to a selected temperature within a range of about −150° C. to about 350° C.

In one embodiment, the method comprises heating the FRP to a selected temperature within a range of about 50 to 350° C.

In one embodiment, the method comprises heating the FRP to a selected temperature within a range of about 140 to 180° C.

In various embodiments, the mechanical force is one or more of tensile force, compressive force, shear force, and torsion. In one embodiment, the mechanical force comprises shear force.

In one embodiment, the method comprises monitoring torque of the at least one rotor; and controlling speed of the at least one rotor to maintain a selected torque.

In various embodiments, the speed of the at least one rotor is controlled at a selected rate of about 0.1-450 rotations per minute (rpm).

The method may comprise maintaining the torque within a selected range of about 10-80 Nm.

According to embodiments, length of recovered fibres that are substantially free of polymer is substantially the same as length of fibres in the FRP.

The method may comprise heating or cooling the FRP prior to applying the mechanical force.

In one embodiment, the mechanical force applied to the FRP is variable.

The method may comprise sieving to separate recovered fibres from the polymer resin powder.

The method may comprise vibrating the FRP in the machine.

According to another aspect, there is provided a machine for carrying out a method for processing FRP material as described herein.

In one embodiment, the machine may be an apparatus for recovering fibres and resin powder from fibre reinforced polymer (FRP) material; comprising a processing chamber housing at least one rotor, the processing chamber adapted to receive one or more pieces of the FRP material; at least one motor associated with the at least one rotor, the at least one motor adapted to effect rotation of the at least one rotor; wherein rotation of the at least one rotor applies a mechanical force to the FRP material that does not damage the fibres; wherein a clearance distance between the at least one rotor and a processing chamber wall is reduced over a portion of the rotor diameter; wherein a combination of the mechanical force and the selected temperature applied to the FRP material for a selected duration provides fibres that are substantially free of polymer, and polymer resin powder.

In one embodiment, the at least one rotor and the processing chamber are configured to apply variable force to the FRP material as the at least one rotor rotates.

In one embodiment, the apparatus comprises a thermal element that heats or cools the processing chamber.

In one embodiment, the mechanical force is one or more of tensile force, compressive force, shear force, and torsion.

In one embodiment, the mechanical force comprises shear force.

In one embodiment, the apparatus comprises a controller, wherein the controller performs one or more of monitoring torque of the at least one rotor; controlling speed of the at least one rotor to maintain a selected torque, monitoring temperature of the processing chamber, and controlling temperature of the processing chamber.

In one embodiment, the FRP material comprises fibres, polymer, and optionally a filler or an additive.

In one embodiment, the fibres comprise glass, carbon, aramid, basalt, natural fibres, silk, cellulose, wood, cork, flax, sasal, jute, hemp, kenaf, and coir, or a combination of two or more thereof.

In one embodiment, the fibres in the FRP material are individual fibres or are arranged as a cloth or mat.

In one embodiment, the polymer comprises epoxy, vinyl polyester, polyester, polyurethane, or phenolic resin, optionally with a filler or additive comprising one or more of calcium carbonate, aluminum, graphite, silica, nanoclay, kaolin, talc, carbon black, carbon nanotubes, gypsum, silicon carbide, boron nitride, rice husk, wheat husk, and coconut coir.

In one embodiment, the apparatus further comprises a vibrating element that vibrates the FRP material in the processing chamber.

In one embodiment, the apparatus further comprises a thermal element that heats and/or cools the processing chamber to a selected temperature that does not damage the fibres.

In one embodiment, the apparatus comprises two or more rotors that apply mechanical force to the FRP material.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIGS. 1A and 1B are schematic diagrams of an apparatus, according to two embodiments of the invention.

FIG. 2 is a plot of torque and temperature profiles within a batch mixer chamber of an apparatus used to carry out a method according to one embodiment.

FIGS. 3A and 3B are photographs showing glass fibre reinforced polymer (GFRP) starting material (Sample A, see Example 1); and

FIG. 3C is a photograph showing recovered glass fibre after processing, according to one embodiment.

FIGS. 4A-4D are photographs showing end-of-life vessel GFRP starting material, coupon size pieces subjected to processing, recovered glass fibre, and recovered resin powder after processing, respectively, according to an embodiment used with Sample C (see Example 1).

FIGS. 5A and 5B are scanning electron microscope images of recovered glass fibre.

FIG. 6 is a plot of mechanical properties of composite materials based on virgin glass fibre (vFG) and recovered glass fibre (rFG), using recovered resin powder (RP) as filler, with data for neat polymer (NP) for reference, according to embodiments described herein.

FIGS. 7A-7D are photographs showing carbon fibre reinforced polymer (CFRP) panel starting material, coupon size pieces subjected to processing, recovered carbon fibre, and recovered resin powder after processing, respectively, according to an embodiment.

FIGS. 8A-8C are photographs showing an aramid/epoxy composite material as obtained, coupon-size pieces of the material for processing, and intact aramid fibre cloth obtained after processing, respectively, according to one embodiment.

### DETAILED DESCRIPTION OF EMBODIMENTS

Described herein are methods for separating FRP into at least two components, fibres and polymer resin powder. Whereas most prior recycling techniques exploit the difference in response of fibres and resins under certain processing conditions to separate fibres from the resins, such conditions are typically extreme and are not favorable economically or environmentally. The methods described herein recognize the drawbacks of such prior methods, and instead provide a viable solution that exploits the advantages of combining low to mild processing conditions of temperature (i.e., heating or cooling) and mechanical force to produce high quality materials from FRP. A heating (thermo-) or cooling (cryo-) mechanical process according to embodiments described herein, also referred to generally as a thermomechanical process, produces high quality fibres (referred to herein as “recovered fibres”) and resin powder (referred to herein as “recovered resin powder”) from various FRP materials, such as those with glass fibres and with carbon fibres. The methods are energy efficient, economically viable, and ecologically sustainable (i.e., no chemicals or additives are required, and no harmful chemicals are released).

According to embodiments, fibres recovered from FRP are high quality as evaluated by comparing mechanical properties such as strength and fibre length before and after recovery, and by comparing mechanical properties of FRP materials prepared from recovered fibres to those of FRP materials prepared from virgin fibres. Embodiments may be useful in recycling operations, by diverting waste FRP materials from landfill and converting them to high quality reusable products, i.e., recovered fibres and resin powder, which may be used in manufacturing new FRP items.

As used herein, the term “mechanical force” refers to one or more of tensile force, compressive force, shear force, and torsion.

As used herein, the term “resin powder” refers a component of a FRP material that is recovered from processing as described herein. A resin powder includes one or more polymers together with any additive or filler that is present in the FRP material.

According to embodiments, FRP is subjected to a combination of a selected temperature (i.e., heating or cooling) and mechanical force, which results in separation of the fibres from the polymer. By selecting an appropriate combination of conditions, fibres may be recovered intact, and polymer, together with any additives that are present in the FRP, is recovered as resin powder. The recovered products are reusable, thus, recycling of FRP material is possible.

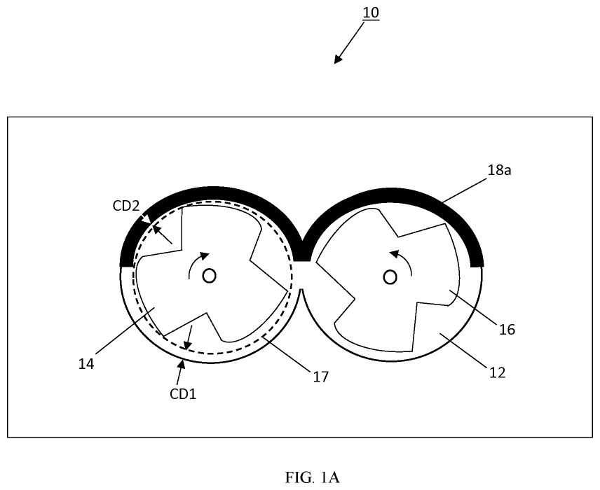

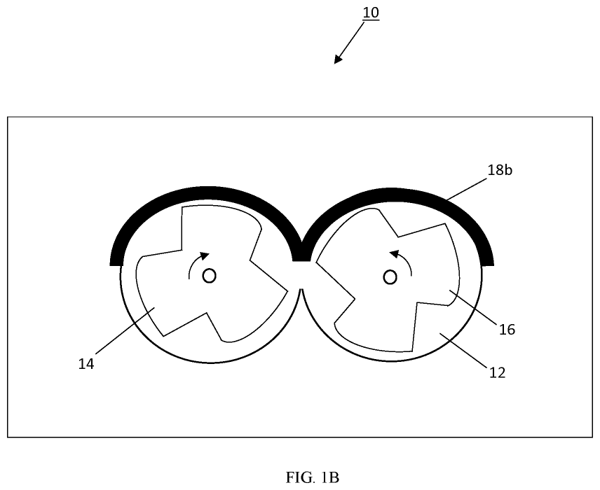

Embodiments may employ an apparatus adapted to apply a combination of mechanical force and heating or cooling to FRP being processed. For example, as shown schematically in FIGS. 1A and 1B, an apparatus 10 has a compartment or chamber 12 into which FRP material is loaded, and may have one or more actuators (also referred to herein as blades or rotors) 14, 16 disposed in the chamber and configured to apply mechanical force to the FRP as they are rotated. In embodiments having e.g., two rotors, the rotor speeds may be the same (i.e., 1:1) or different, where different rotor speeds may be variable or fixed and may be based on a ratio, e.g., up to about 1:1.5. The dashed line 17 in FIG. 1A represents an overall rotor diameter. In some embodiments, the rotors may be configured for counter-rotation; see, e.g., the curved arrows indicating rotation of the rotors in FIGS. 1A and 1B. Such a machine may be built specifically for processing FRP, or existing machines, e.g., single and double arm (rotor) mixers, rubber kneaders, compounding machines, batch mixers, and banbury mixers, etc., may be modified by adding features required for processing FRP (see, e.g., Example 4 below). For example, the processing chamber geometry, which includes the shape of the chamber, clearance of the rotor(s) to the chamber wall, and design/shape of the rotors must be designed such that sufficient force is applied to the FRP to degrade it to fibre and resin powder without damaging the fibres. Typically, existing machines are designed for mixing liquids, powders, or pastes, and they cannot generate sufficient torque or mixing power to break down solid composite FRP structures. To achieve satisfactory processing, one or more of the following features may be implemented in a custom machine and/or as a modification to an existing machine:

1. A wall may be disposed above the rotor(s) to improve shearing and compression forces within the chamber. For example, as shown in FIGS. 1A and 1B, a wall 18a or 18b may be disposed above the rotors 14, 16. The wall 18a or 18b reduces the clearance distance between the rotors and the chamber, thereby increasing the mechanical force applied to the FRP material as the rotor rotates. For example, as shown schematically in FIG. 1A, the clearance distance CD2 between the wall 18a and the rotor diameter 17 is reduced relative to the clearance distance CD1 elsewhere in the chamber 12. The wall may be tapered, so that force is increased as the rotor rotates. In FIG. 1A, for example, the taper of the wall 18a may be longitudinal, i.e., along the direction of the axis of rotation of the rotor(s). Alternatively, and/or additionally, as shown in FIG. 1B, the wall 18b may have a radial taper with respect to the rotor axis of rotation so as to avoid a step or transition where FRP material enters. As an example, in one embodiment having a rotor diameter of about 3.9 inches (about 9.91 cm), the clearance between the rotor and wall 18a or 18b may be reduced to about 0.3 inches (about 0.76 cm). Of course, the clearance may be scaled according to the size of the rotor and may be optimized for a given FRP material being processed.

2. Rotor (blade) geometry may be optimized according to, e.g., the chamber design/features. For example, optimizing may include use of a rotor geometry based on a design such as, but not limited to, sigma, roller, cam, banbury, masticator, or delta.

3. Large electric motor(s) and/or heavy duty drive train or gearbox may be used to achieve high power and generate sufficient torque.

According to one embodiment, the one or more actuators comprise one or more rotors that rotate upon respective axes in the chamber, the rotor(s) being driven by one or more motors. The one or more actuators are configured such that contact with FRP results in mechanical force applied to the FRP. For example, the actuators may apply a shear force to the FRP. In one embodiment the apparatus may include one or more controllers for setting the speed of the motor(s), and hence the speed of the actuator(s) (e.g., the controller may be used to control a shear rate). A heating or cooling element may be provided for heating or cooling the chamber and the FRP material. In one embodiment the apparatus may include a controller for one or more of monitoring the response of the FRP material to the mechanical force, and provide a measure, such as torque, and monitoring and setting the temperature by controlling the heating or cooling element. Thus, for a given FRP material, a characteristic set of processing parameters (e.g., parameters such as, but not limited to, force, temperature, speed, and time) may be selected to achieve optimum results, that is, sufficient mechanical force to disintegrate the polymer to a resin powder without damaging the fibre, so that high quality fibre and resin powder products are recovered. Such machine may be scalable such that large quantities and sizes of FRP may be processed. However, in the case of large FRP items to be processed, simple pre-processing may be required; for example, it might be necessary to cut an FRP item into pieces of appropriate size for processing.

An example of such a machine is an electrically heated Haake Rheomix QC intensive batch mixer (Thermo Fisher Scientific Inc.), which has a chamber equipped with two roller rotors, a hopper, and a ram. This machine is typically used in laboratory settings for polymer processing and testing polymer degradation behaviour. Surprisingly, however, use of such machine in preliminary tests for processing FRP as described herein produced favourable results. It is expected that features of this machine may be scaled or incorporated into large machines that would permit processing parameters (e.g., one or more of force, temperature, speed, and time) to be selected to achieve optimum results in large-scale FRP processing and recycling operations.

Based on such a machine, processing parameters may be selected to include subjecting the FRP to a temperature of about −150° C. to about 350° C., and applying mechanical force to the FRP by rotating the one or more rotor at a rate of about, e.g., 0.1 to 450 rotations per minute (rpm), for a duration sufficient to achieve separation and recovery of high quality fibre and resin powder products. Rotating the one or more rotor may result in the FRP being subjected to mechanical shear. In one embodiment, mechanical force applied to the FRP is assessed by monitoring torque at the one or more rotors. For example, torque may be monitored continuously or at intervals throughout the process, and the rotor speed adjusted as necessary to maintain the torque at a selected level, e.g., for small-scale operations, at or between 10-50 Nm. Of course, the parameters are selected to optimize the process according to, e.g., the type of FRP being treated, the scale of processing, etc. After processing, the resulting material may be sieved to isolate the separated fibres from the polymer resin powder.

Examples of FRP that may be processed include, but are not limited to, those with fibres made of one or more of glass, carbon, aramid (aromatic polyamide), basalt, natural fibres, silk, cellulose, wood, cork, flax, sasal, jute, hemp, kenaf, and coir, and with polymer based on epoxy, vinyl polyester, polyester, polyurethane, or phenolic resin, optionally with a filler or additive such as calcium carbonate, aluminum, alumina, graphite, silica, nanoclay, kaolin, talc, carbon black, carbon nanotubes, gypsum, silicon carbide, boron nitride, rice husk, wheat husk, and coconut coir. FRPs based on such materials may be used in products found in industrial, technological, power generation, sporting, transportation, aerospace and defence, and construction applications, among others. Examples of products include, but are not limited to, wind turbine blades, printed circuit boards, vehicle parts (boats, airplanes, and cars), helmets, bathroom fixtures, appliances, small scale piping, and roofing.

The invention is further described by way of the following non-limiting examples.

### Example 1. Processing of Glass Fibre Reinforced Polymer

### Material

Glass fibre reinforced polymer (GFRP) samples from three sources: GFRP based on epoxy resin from Queen's University Civil Engineering (Sample A); Fiber-Lite FRP panels—glass fibre and calcium carbonate filled polyester resin from Nudo Products, Inc. (Illinois, USA) (Sample B); and GFRP panel from an end-of-life vessel obtained from a local marina (Sample C) were used in this study. Fibre sizing (FGLASS™ X35) was obtained from Michelman (Ohio, USA) and virgin glass fibre, C6-04K (polypropylene (PP) compatible, chopped strands, l=4.5 mm) was from Fiberlink Inc. (Ontario, Canada). Polypropylene, Pro-fax® PD702 (density—0.9 g/cm³, MFR—35.0 g/10 min (@ 2.16 kg, 230° C.) was purchased from Lyondellbasell, and Fusabond® P353 (chemically modified polypropylene copolymer density—0.904 g/cm³, MFR—22.4 g/10 min (160° C.), very high maleic anhydride content) from DuPont Canada.

### Equipment

To gently separate the glass fibre from the polymer resin, through the combined effect of heating and mechanical force, an electrically heated Haake Rheomix 600 QC intensive batch mixer was used. This unit had a chamber volume of 120 cm 3, and was equipped with roller rotors, a hopper, and a ram. The Rheomix batch mixer was connected to a ThermoFisher PolyLab QC Unit. This equipment is typically used in thermoplastic melt compounding operations. The equipment had a built-in torque sensor, capable of continuously monitoring torque during processing of the material. As described below, this permitted monitoring the quality of the recovered glass fibre by ensuring that the torque was within an optimum range (i.e., sufficient mechanical shear to disintegrate the resin without causing damage to the glass fibre).

### Processing

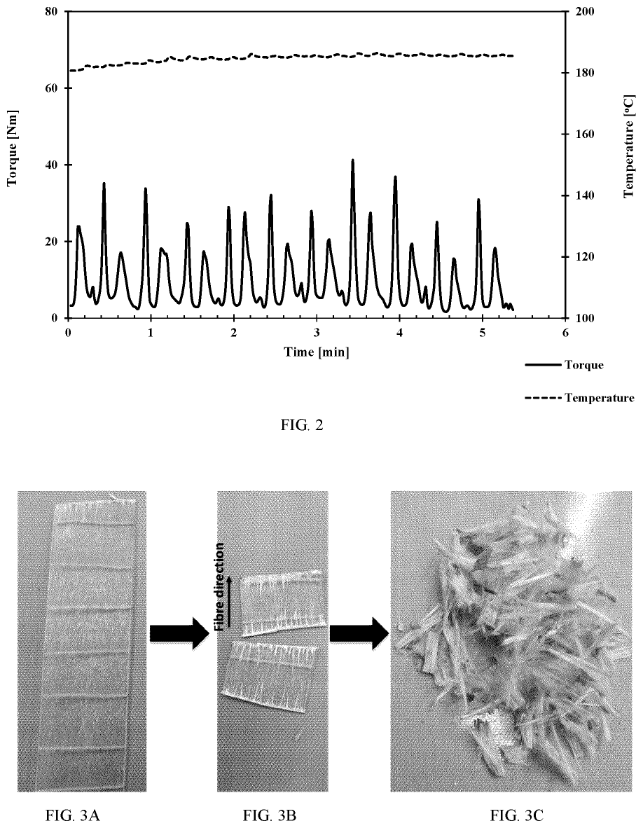

GFRP was cut into coupon size pieces approximately 2×4 cm and coupons (20 g) were loaded in the Rheomix batch mixer (fill factor of 0.7) and processed at a temperature of 180° C. and rotor speed of 1-2 rpm for 5 minutes. The torque was continuously monitored throughout the process and maintained below 50 Nm, resulting in the representative trend shown in FIG. 2. The processed material was removed from the mixer chamber after 5 minutes and then the glass fibre and resin powder were separated by dry sieving. The recycled glass fibre obtained was washed twice in 0.1 vol % aqueous solution of fibre sizing (FGLASS™ X35, compatible with PP) and vacuum dried overnight at 80° C. The washing step was necessary to remove residual resin powder and to modify the fibre surface for enhanced fibre-matrix compatibility and bonding with PP in the processing of recycled glass fibre/PP composites, described below.

### Composites Processing and Characterization

Thermoplastic composites of recycled glass fibre/PP, virgin glass fibre/PP, and resin powder/PP at a fibre/filler content of 10-20 wt % were produced by melt mixing in the Rheomix mixer at a temperature of 180° C. and rotor speed of 50 rpm for 6 minutes. Samples for three-point bending flexural, Izod Impact (notched), and electrical conductivity tests were compression molded, using appropriate molds, at 180° C. for 2 minutes in a Carver press. Flexural tests were performed on an Instron 3369 Universal tester, at a cross head speed of 1.3 mm/min using the 3-point bending method according to ASTM D790 standard. Impact tests were performed on a BLI impact tester according to ASTM D256 standard. Five specimens were tested for each sample and the standard deviations are reported as per standard method.

### Results and Discussion

The results demonstrate that high quality recycled materials were produced from all three samples (A, B and C) through a combination of heat and mechanical shear. Average energy requirement for processing was estimated to be less than 0.002 MJ/kg, which is significantly less than prior mechanical processes ranging between 0.14-0.32 MJ/kg [16], while the energy requirement for the production of virgin glass fibre is in the range of 13-32 MJ/kg [1].

Sample A was processed according to the procedure described in the experimental section. High quality recycled glass fibre was successfully extracted after the resin was pulverized (see FIGS. 3A-3C).

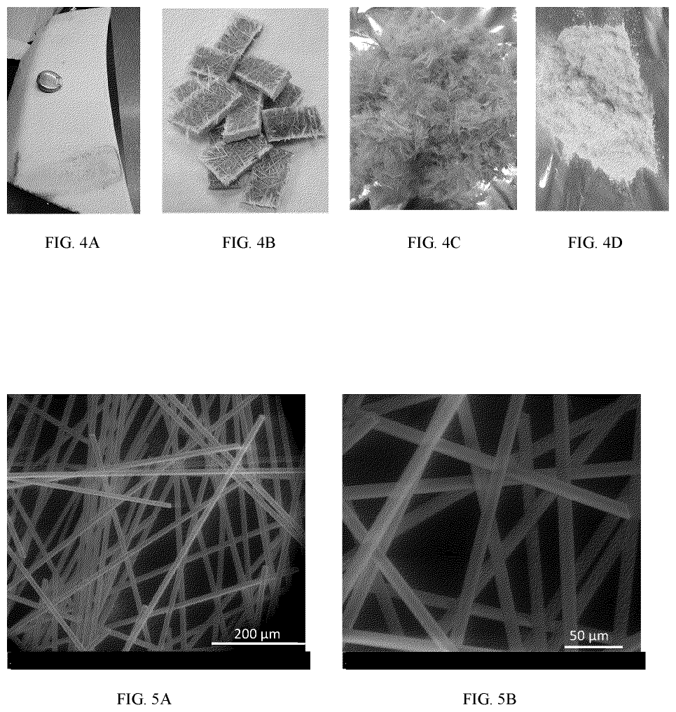

The process was taken through a series of iterative steps to meet all desired outcomes, i.e., to optimize recovered fibre quality, cost effectiveness, and process scalability. All samples (A, B, and C) were processed using the optimized solution to produce high quality glass fibre and resin powder. Results for Sample C are shown in FIGS. 4A-4D. Results for Sample B were substantially the same. The recovered glass fibre was used for reinforcement and the recovered resin powder was used as filler for further processing of polymer composites.

Quality of recovered glass fibre (rFG) from Sample A was evaluated by assessing the fibre length before and after processing, and visually by scanning electron microscopy (SEM). Fibre length (about 25 mm) was retained after processing. SEM imaging (FIGS. 5A and 5B) showed that recovered glass fibres were undamaged (i.e., free of scratches, cuts, breakages, fracture, rupture, etc.) and were visually comparable to virgin glass fibres.

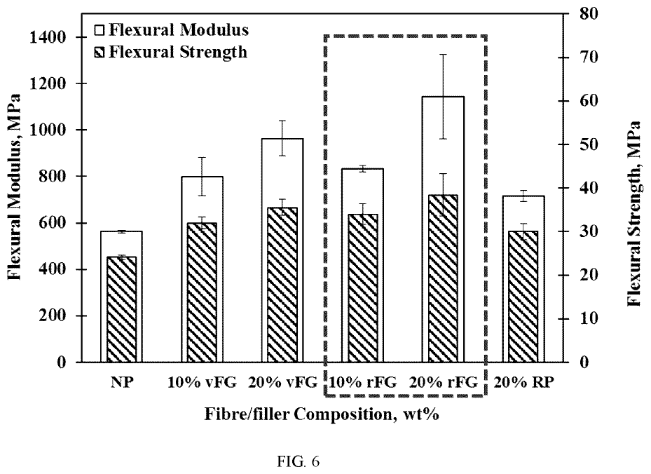

Further, quality of (rFG) was evaluated by comparing mechanical properties of polymer composites made with recovered or virgin glass fibre (vFG). Polymer composites were also produced using recovered resin powder (RP) as filler. Results show that recovered glass fibre composites have superior flexural modulus and strength relative to virgin glass fibre composites (FIG. 6). FIG. 6 also shows data for neat polymer (NP) (i.e., no glass fibre) for reference.

### Example 2. Processing of Carbon Fibre Reinforced Polymer

A carbon fibre reinforced polymer (CFRP) material (Quantum Lytex® 4149 Sheet Molding Compound, an epoxy based composite reinforced with 3K PAN carbon fibre) obtained from Quantum Composites (Bay City, MI) was subjected to a process similar to that described above in Example 1.

The Lytex 4149 Sheet Molding Compound (2 mm thick) was cut into squares of 10×10 cm and cured by compression moulding on a Carver press at 170° C. for 15 minutes (as recommended by the supplier). The cured composite sheet was cut into coupon sizes approx. 2×4 cm prior to feeding into the Haake Rheomix batch mixer (see Example 1) at 10-15 g per batch. Processing parameters were set at 200° C., 5 rpm for 10 minutes. After processing, the products were removed from the mixing chamber and carbon fibres were separated from the resin powder by sieving using a vibrating grid.

The Lytex 4149 Sheet Molding Compound is reinforced with carbon fibre with nominal length of 25 mm (as indicated in the product information sheet). Visual inspection of the recovered carbon fibres showed that the fibre length was retained, indicating that the process had no adverse effect on the properties of the fibres.

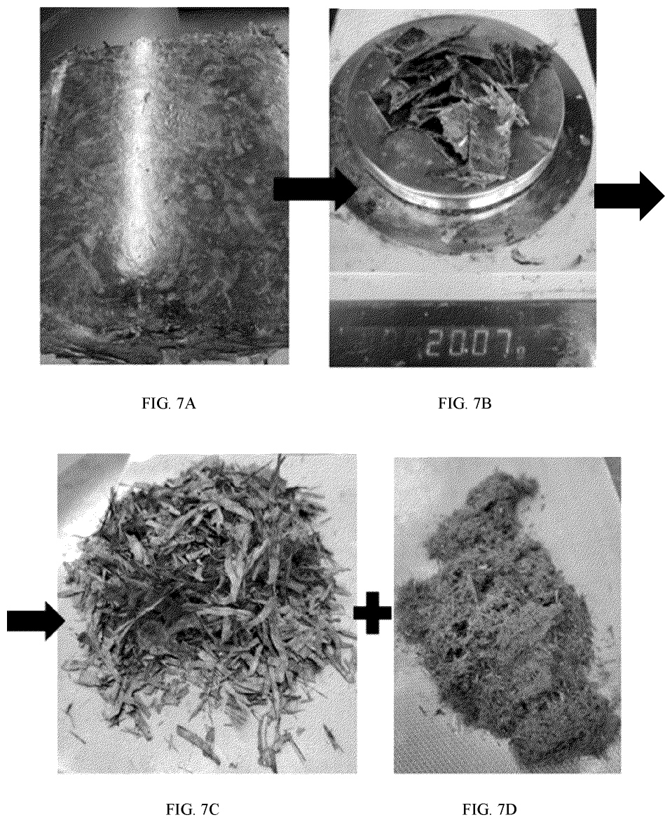

FIGS. 7A-7D are photographs showing the Lytex carbon fibre reinforced polymer panel starting material, coupon size pieces subjected to processing, recovered high quality carbon fibre, and recovered resin powder after processing, respectively.

### Example 3. Processing of Honeycomb and Laminate Composite Structures

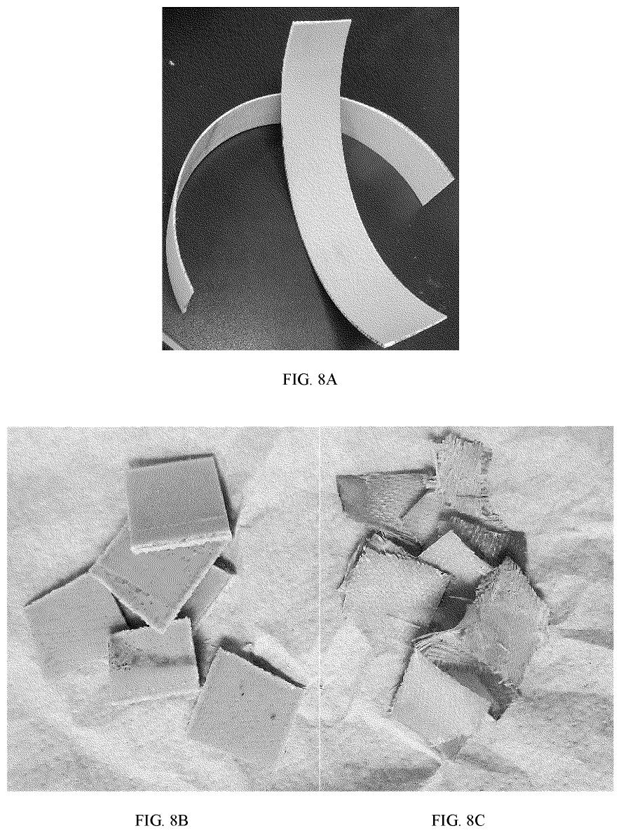

A process similar to that described above in Example 1, using the Haake Rheomix batch mixer, was used to extract fibre cloth from a composite material used for aerospace applications. The composite material was made from four layers of woven aramid fibre cloth bound together with an epoxy resin. The material was manufacturing waste supplied by a Canadian aerospace company. FIGS. 8A and 8B are photographs of the aramid/epoxy material as supplied and cut into coupon-size pieces for processing, respectively. The coupon-size pieces were processed using the Haake mixer at 180° C. and 2 rpm, and the material was completely processed within 5 minutes to extract the aramid fibre cloth intact as shown in FIG. 8C, and epoxy resin powder.

### Example 4. Processing FRP with Double Arm Mixer

A Jaygo Double Arm Sigma Blade Mixer, Model NHF-5 (Jaygo, Inc., Randolph, NJ, USA) with a total mixing chamber capacity of 5 L was modified for processing FRP. The mixing chamber was a double trough shell with end plates fabricated from steel plate. Trough and end plates were ground and polished smooth. Tangential mixing action was provided by sigma blades made of 304 cast stainless steel including stainless steel shafts, supported by outboard bearings and driven by heavy-duty gearing. The trough was jacketed and designed for 14.9 psig pressure water or oil at 220° C. with insulation and sheathing over all jacketed surfaces and NPT jacket connections on upper sections of the mixer trough and a drain in bottom center of the jacket. The blades were driven by a 1 HP TEFC motor direct connected to a right angle gearbox, coupling, and end case gear reducer. The blades speeds were variable, approx. 0-70 RPM for the front blade and 0-50 RPM the rear blade, and the ratio between blade speeds was fixed at 7:5.

All cited publications are incorporated herein by reference in their entirety.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

### REFERENCES

[1] G. Oliveux, L. O. Dandy, G. A. Leeke, Current status of recycling of fibre reinforced polymers: Review of technologies, reuse and resulting properties, Prog. Mater. Sci. 72 (2015) 61-99. doi:10.1016/J.PMATSCI.2015.01.004.
[2] J. Palmer, O. R. Ghita, L. Savage, K. E. Evans, Successful closed-loop recycling of thermoset composites, Compos. Part A Appl. Sci. Manuf 40 (2009) 490-498. doi:10.1016/j.compositesa.2009.02.002.
[3] S. J. Pickering, Recycling technologies for thermoset composite materials—current status, Compos. Part A Appl. Sci. Manuf 37 (2006) 1206-1215. doi:10.1016/j.compositesa.2005.05.030.
[4] C. E. Kouparitsas, C. N. Kartalis, P. C. Varelidis, C. J. Tsenoglou, C. D. Papaspyrides, Recycling of the fibrous fraction of reinforced thermoset composites, Polym. Compos. 23 (2002) 682-689. doi:10.1002/pc.10468.
[5] Office for the London Convention/Protocol and Ocean Affairs, End-Of-Life Management of Fibre Reinforced Plastic Vessels: Alternatives to At Sea Disposal, London, United Kingdom, 2019. http://www.imo.org/en/OurWork/Environment/LCLP/newandemergingissues/Documents/Fib re Reinforced Plastics final report.pdf (accessed Sep. 22, 2019).
[6] V. Vladimirov, I. Bica, Mechanical Recycling: Solutions for Glass Fibre Reinforced Composites, in: National Research and Development Institute for Industrial Ecology (Ed.), Int. Symp. “Environment Ind., Bucharest, Romania, 2017: pp. 1-7. http://www.simiecoind.ro/wp-content/uploads/2017/10/MECHANICAL-RECYCLING-SOLUTIONS-FOR-GLASS-FIBREOAREINFORCED-COMPOSITES.pdf (accessed Sep. 22, 2019).
[7] V. Marković, S. Marinković, A study of pyrolysis of phenolic resin reinforced with carbon fibres and oxidized pan fibres, Carbon N. Y. 18 (1980) 329-335. doi:10.1016/0008-6223(80)90004-4.
[8] A. Torres, I. de Marco, B. M. Caballero, M. F. Laresgoiti, J. A. Legarreta, M. A. Cabrero, A. Gonzalez, M. J. Chomón, K. Gondra, Recycling by pyrolysis of thermoset composites: characteristics of the liquid and gaseous fuels obtained, Fuel. 79 (2000) 897-902. doi:10.1016/S0016-2361(99)00220-3.
[9] A. M. Cunliffe, P. T. Williams, Characterisation of products from the recycling of glass fibre reinforced polyester waste by pyrolysis*, Fuel. 82 (2003) 2223-2230. doi:10.1016/S0016-2361(03)00129-7.
[10] S. J. Pickering, R. M. Kelly, J. R. Kennerley, C. D. Rudd, N. J. Fenwick, A fluidised-bed process for the recovery of glass fibres from scrap thermoset composites, Compos. Sci. Technol. 60 (2000) 509-523. doi:10.1016/S0266-3538(99)00154-2.
[11] S. Feih, E. Boiocchi, G. Mathys, Z. Mathys, A. G. Gibson, A. P. Mouritz, Mechanical properties of thermally-treated and recycled glass fibres, Compos. Part B Eng. 42 (2011) 350-358. doi:10.1016/J.COMPOSITESB.2010.12.020.
[12] D. Åkesson, Z. Foltynowicz, J. Christéen, M. Skrifvars, Microwave pyrolysis as a method of recycling glass fibre from used blades of wind turbines, J. Reinf. Plast. Compos. 31 (2012) 1136-1142. doi:10.1177/0731684412453512.
[13] M. Buggy, L. Farragher, W. Madden, Recycling of composite materials, J. Mater. Process. Technol. 55 (1995) 448-456. doi:10.1016/0924-0136(95)02037-3.
[14] W. Dang, M. Kubouchi, S. Yamamoto, H. Sembokuya, K. Tsuda, An approach to chemical recycling of epoxy resin cured with amine using nitric acid, Polymer (Guildf). 43 (2002) 2953-2958. doi:10.1016/S0032-3861(02)00100-3.
[15] K. H. Yoon, A. T. DiBenedetto, S. J. Huang, Recycling of unsaturated polyester resin using propylene glycol, Polymer (Guildf). 38 (1997) 2281-2285. doi:10.1016/S0032-3861(96)00951-2.
[16] N. A. Shuaib, P. T. Mativenga, Effect of Process Parameters on Mechanical Recycling of Glass Fibre Thermoset Composites, Procedia CIRP. 48 (2016) 134-139. doi:10.1016/J.PROCIR.2016.03.206.

1. A method for recovering fibres and resin powder from fibre reinforced polymer (FRP) material; comprising:
disposing FRP material in a machine having at least one rotor, and simultaneously:
operating the at least one rotor to apply mechanical force to the FRP material; and
subjecting the FRP material to a selected temperature that does not damage the fibres;
wherein the combination of mechanical force and selected temperature for a selected duration provides fibres that are substantially free of polymer, and polymer resin powder.

2. The method of claim 1, comprising subjecting the FRP material to a selected temperature within a range of about −150° C. to about 350° C.

3. The method of claim 1, comprising heating the FRP material to a selected temperature within a range of about 50 to 350° C.

4. The method of claim 1, comprising heating the FRP material to a selected temperature within a range of about 140 to 180° C.

5. The method of claim 1, wherein the mechanical force is one or more of tensile force, compressive force, shear force, and torsion.

6. The method of claim 1, wherein the mechanical force comprises shear force.

7. The method of claim 1, comprising monitoring torque of the at least one rotor; and
controlling speed of the at least one rotor to maintain a selected torque.

8. The method of claim 7, wherein the speed of the at least one rotor is controlled at a selected rate of about 0.1-450 rotations per minute (rpm).

9. The method of claim 7, wherein the torque is maintained within a selected range of about 10-80 Nm.

10. The method of claim 1, wherein length of the fibres that are substantially free of polymer is substantially the same as length of fibres in the FRP material.

11. The method of claim 1, wherein the FRP comprises fibres, polymer, and optionally a filler or an additive.

12. The method of claim 1, wherein the fibres comprise glass, carbon, aramid, basalt, natural fibres, silk, cellulose, wood, cork, flax, sasal, jute, hemp, kenaf, and coir, or a combination of two or more thereof.

13. The method of claim 1, wherein the fibres in the FRP material are individual fibres or are arranged as a cloth or mat.

14. The method of claim 1, wherein the polymer comprises epoxy, vinyl polyester, polyester, polyurethane, or phenolic resin, optionally with a filler or additive comprising one or more of calcium carbonate, aluminum, graphite, silica, nanoclay, kaolin, talc, carbon black, carbon nanotubes, gypsum, silicon carbide, boron nitride, rice husk, wheat husk, and coconut coir.

15. The method of claim 1, comprising heating or cooling the FRP material prior to applying the mechanical force.

16. The method of claim 1, wherein the mechanical force applied to the FRP material is variable.

17. The method of claim 1, further comprising sieving to separate fibres from the polymer resin powder.

18. The method of claim 1, further comprising vibrating the FRP material in the machine.

19. The method of claim 1, wherein the machine comprises two or more rotors that apply mechanical force to the FRP material.

20. Apparatus for recovering fibres and resin powder from fibre reinforced polymer (FRP) material; comprising:
a processing chamber housing at least one rotor, the processing chamber adapted to receive one or more pieces of the FRP material;
at least one motor associated with the at least one rotor, the at least one motor adapted to effect rotation of the at least one rotor;
wherein rotation of the at least one rotor applies a mechanical force to the FRP material that does not damage the fibres;
wherein a clearance distance between the at least one rotor and a processing chamber wall is reduced over a portion of the rotor diameter;
wherein a combination of the mechanical force and the selected temperature applied to the FRP material for a selected duration provides fibres that are substantially free of polymer, and polymer resin powder.

21. The apparatus of claim 20, wherein the at least one rotor and the processing chamber are configured to apply variable force to the FRP material as the at least one rotor rotates.

22. The apparatus of claim 20, comprising a thermal element that heats or cools the processing chamber.

23. The apparatus of claim 20, wherein the mechanical force is one or more of tensile force, compressive force, shear force, and torsion.

24. The apparatus of claim 20, wherein the mechanical force comprises shear force.

25. The apparatus of claim 20, comprising a controller, wherein the controller performs one or more of monitoring torque of the at least one rotor; controlling speed of the at least one rotor to maintain a selected torque, monitoring temperature of the processing chamber, and controlling temperature of the processing chamber.

26. The apparatus of claim 20, wherein the FRP material comprises fibres, polymer, and optionally a filler or an additive.

27. The apparatus of claim 20, wherein the fibres comprise glass, carbon, aramid, basalt, natural fibres, silk, cellulose, wood, cork, flax, sasal, jute, hemp, kenaf, and coir, or a combination of two or more thereof.

28. The apparatus of claim 20, wherein the fibres in the FRP material are individual fibres or are arranged as a cloth or mat.

29. The apparatus of claim 20, wherein the polymer comprises epoxy, vinyl polyester, polyester, polyurethane, or phenolic resin, optionally with a filler or additive comprising one or more of calcium carbonate, aluminum, graphite, silica, nanoclay, kaolin, talc, carbon black, carbon nanotubes, gypsum, silicon carbide, boron nitride, rice husk, wheat husk, and coconut coir.

30. The apparatus of claim 20, further comprising a vibrating element that vibrates the FRP material in the processing chamber.

31. The apparatus of claim 20, comprising a thermal element that heats and/or cools the processing chamber to a selected temperature that does not damage the fibres;

32. The apparatus of claim 20, comprising two or more rotors that apply mechanical force to the FRP material.
